(19) United States
(12) Patent Application Publication
(10) Pub. No.: US 2021/0118333 A1
(43) Pub. Date: Apr. 22, 2021

(54) SAVE-A-CHILD WARNING DEVICE

(71) Applicant: Angela McFarland, Tampa, FL (US)

(72) Inventor: Angela McFarland, Tampa, FL (US)

(21) Appl. No.: 17/034,107

(22) Filed: Sep. 28, 2020

Related U.S. Application Data
(60) Provisional application No. 62/923,808, filed on Oct. 21, 2019.

(51) Int. Cl. G09F 3/02; G08B 5/00; G09F 3/14; G09F 7/12; G09F 3/10; G09F 21/04

(52) U.S. Cl. CPC G09F 3/02; G08B 5/00; G09F 3/14; G09F 2007/127; G09F 3/10; G09F 21/04; G09F 2007/122; G09F 7/12

(57) ABSTRACT

An article of manufacture for providing a warning reminder that human and animal passengers are in the backseat of a vehicle according to the present invention is disclosed. The warning reminder has a message tag body shaped to prompt a driver to check the back seat, a warning text message to prompt a driver to check the back seat, and a warning graphic prompt a driver to check the back seat. The warning reminder may hang from a string, attach to an inside surface of a vehicle, and attach to a vehicle window to be visible both inside and outside of the vehicle.

### TECHNICAL FIELD

This application relates in general to an article of manufacture for providing a personal safety protection device, and more specifically, to an article of manufacture for a warning reminder that human and animal passengers are in the backseat of a vehicle.

### BACKGROUND

Too many children and pets are injured or killed when drivers inadvertently leave them unattended in a vehicle in warm weather. A driver may become distracted by their thoughts of work and/or personal activities while travelling to a destination. Unfortunately, children and pets are forgotten and left in vehicles by such distracted drivers.

Therefore, a need exists for an article of manufacture for providing a warning reminder that there are human and/or animal passengers in the backseat of an automobile. Such a reminder device placed in a conspicuous location visible as the driver parks and exits a vehicle may interrupt the thoughts of a distracted driver before they leave the automobile unattended. As such, the present invention attempts to address the limitations and deficiencies in existing solutions using the principles and embodiments disclosed herein.

### SUMMARY

In accordance with the present invention, the above and other problems are solved by providing an article of manufacture for a warning reminder that human and animal passengers are in the backseat of a vehicle according to the principles and example embodiments disclosed herein.

In one embodiment, the present invention is an article of manufacture for a warning reminder that human and animal passengers are in the backseat of a vehicle. The warning reminder has a message tag body shaped to prompt a driver to check the back seat, a warning text message to prompt a driver to check the back seat, and a warning graphic prompt a driver to check the back seat. The warning reminder may hang from a string, attach to an inside surface of a vehicle, and attach to a vehicle window to be visible both inside and outside of the vehicle.

Another aspect of the present disclosure, the warning reminder further comprises a string hanger coupled to the message body tag to display the warning reminder within a vehicle.

Another aspect of the present disclosure, the warning reminder further comprises an attachment mechanism for coupling the message body tag to a vehicle.

Another aspect of the present disclosure, the attachment mechanism is a suction cup.

Another aspect of the present disclosure, the attachment mechanism is an adhesive in which the message body tag is a sticker.

Another aspect of the present disclosure, the sticker couples to a vehicle window having the warning text message and the warning graphic being visible both inside and outside the vehicle.

Another aspect of the present disclosure, the warning text message and the warning graphic are made of contrasting colors from the message body tag.

Another aspect of the present disclosure, the message body tag is shaped like a child.

Another aspect of the present disclosure, the message body tag is shaped like a pet.

Another aspect of the present disclosure, the message body tag is shaped like a traffic sign.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example environment requiring an article of manufacture for a warning reminder that human and animal passengers are in the backseat of a vehicle according to the present invention.

FIGS. 2a-b illustrate an example embodiment of an article of manufacture for a warning reminder that human and animal passengers are in the backseat of a vehicle according to the present invention.

FIGS. 3a-b illustrate another example embodiment of an article of manufacture for a warning reminder that human and animal passengers are in the backseat of a vehicle according to the present invention.

FIG. 4 illustrates yet another example embodiment of an article of manufacture for a warning reminder that human and animal passengers are in the backseat of a vehicle according to the present invention.

FIGS. 5a-b illustrate additional example embodiments of an article of manufacture for a warning reminder that human and animal passengers are in the backseat of a vehicle according to the present invention.

### DETAILED DESCRIPTION

This application relates in general to an article of manufacture for providing a personal safety protection device, and more specifically, to an article of manufacture for a warning reminder that human and animal passengers are in the backseat of a vehicle according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “driver,” and “user” refer to an entity, e.g. a human, using the article of manufacture for a warning reminder that human and animal passengers are in the backseat of a vehicle associated with the invention. The term user herein refers to one or more users.

The term “invention” or “present invention” refers to the invention being applied for via the patent application with the title “Save-A-Child Warning Device.” Invention may be used interchangeably with warning reminder or device.

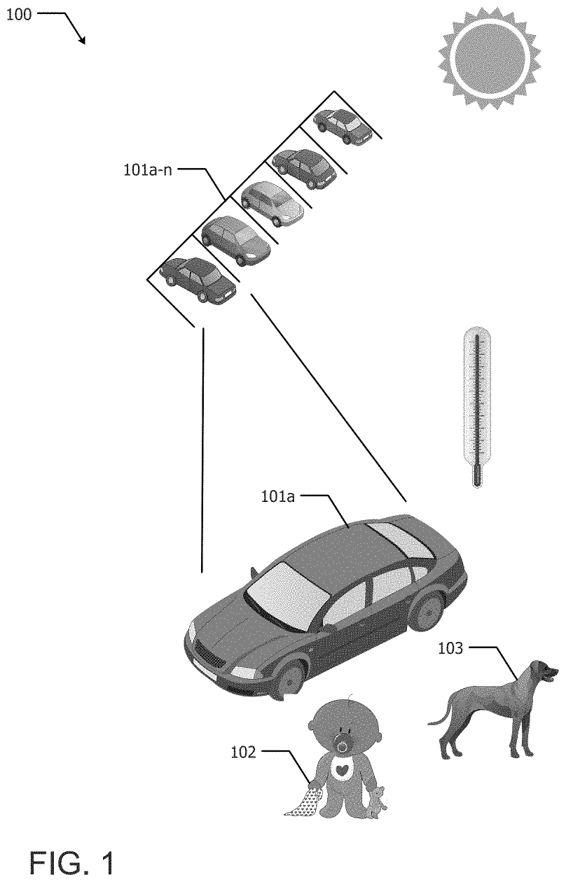

In general, the present disclosure relates to an article of manufacture providing a personal protection device. To better understand the present invention, FIG. 1 illustrates an example environment that requires an article of manufacture for a warning reminder that human and animal passengers are in the backseat of a vehicle according to the present invention. During summer months, sunny days can create dangerous conditions for human 102 and animal 103 passengers left in vehicles 101a-n when they are parked 100. More often than might be expected, people have driven to work or shopping and left passengers in the car 101a by mistake only to discover the error later in the day with unfortunate consequences. These errors may arise as the drivers become unintentionally distracted by thoughts of things they need to attend to when they arrive at a destination. A typical vehicle 101a does not necessarily provide a reminder to check the rear seat(s) area of the vehicle when exiting. Because young children and pets may ride in the backseat area of the vehicle, an easily-seen reminder is needed in the drivers field of view when exiting the vehicle 101a to jog their memories that a passenger needs attention before the driver leaves the vehicle.

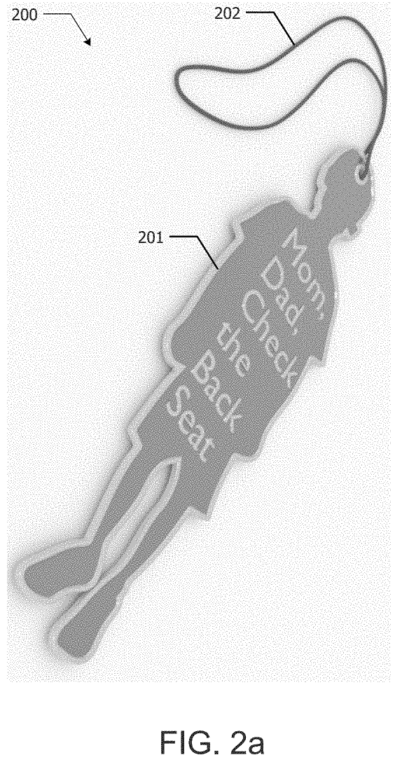

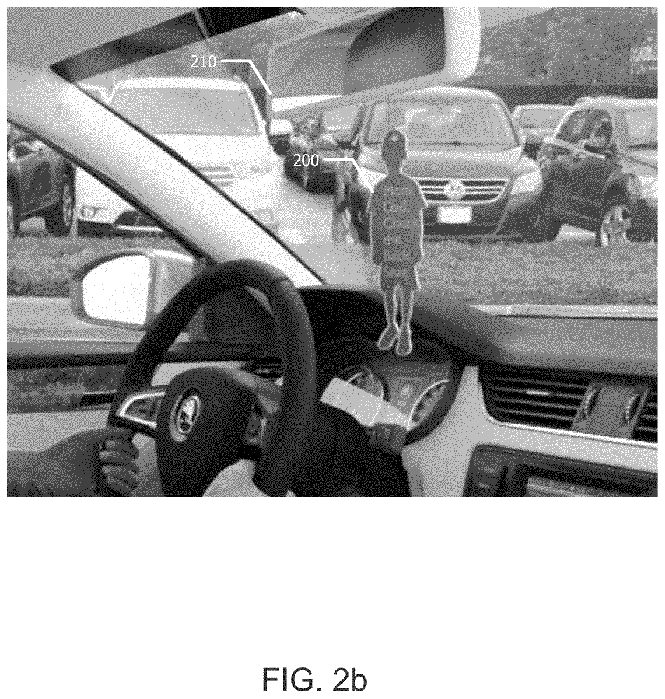

FIGS. 2a-b illustrate an example embodiment of an article of manufacture for a warning reminder that human and animal passengers are in the backseat of a vehicle according to the present invention. A reminder device 200 is shown in FIG. 2a that comprises a message tag body 201 and a string hanger 202 that may be used as a warning device for a driver before he/she exits the vehicle 101a. FIG. 2b shows the reminder device 200 hanging from the rearview mirror 210 of the vehicle 101a.

The reminder device 200 in FIG. 2a-b is shaped to represent a child and presents a readable message of warning that suggests that the driver check the rear of the vehicle 101a when exiting. By hanging the reminder device 200 on the rearview mirror 210, the reminder device 200 will remain within the driver's field of view as he/she parks the vehicle. By seeing the reminder device 200 as the vehicle is turned off, the driver may increase his or her awareness to check the automobile before leaving it unattended. The use of color on the device 200 may assist in keeping the reminder device 200 consciously visible to the driver and thus prevent inadvertent failure to take the passenger to a safe location before continuing on to the activities of the day.

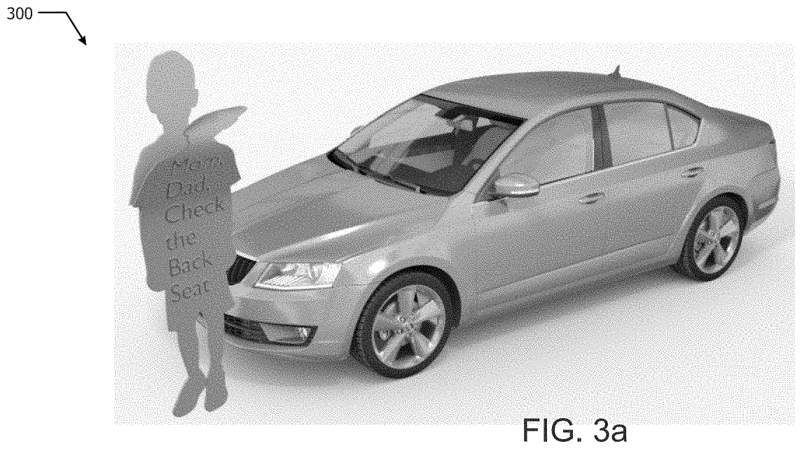

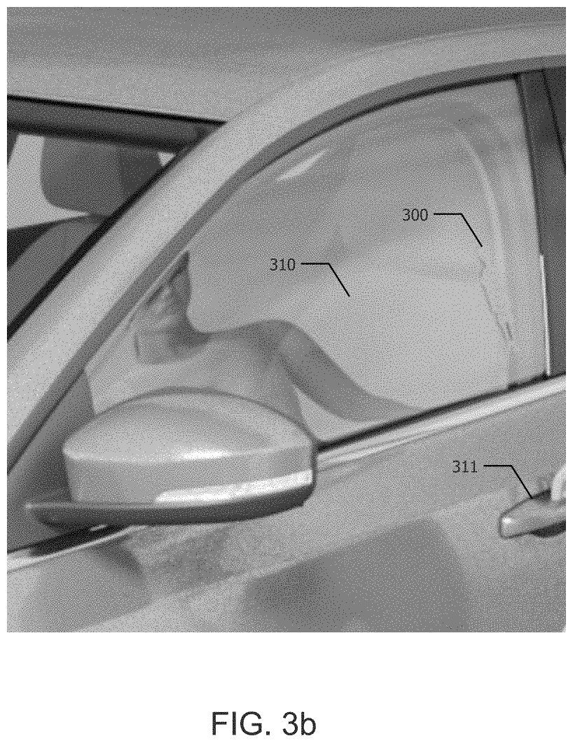

FIGS. 3a-b illustrate another example embodiment of an article of manufacture for a warning reminder that human and animal passengers are in the backseat of a vehicle according to the present invention. FIG. 3a shows a reminder device 300 that is made in the form of a sticker or similar device that may be affixed to the vehicle in a location where it will be easily seen when the driver exits the vehicle. FIG. 3b shows the reminder device 300 placed on a side window 310 near where the driver interacts with the door handle 311 and door lock (not shown) that will be visible as the driver is closing the door and locking it. The reminder device 300 may be located in many other locations in and on the automobile 101a where the reminder device 300 is readily seen when exiting while not presenting an obstacle to the driver's vision when operating the automobile.

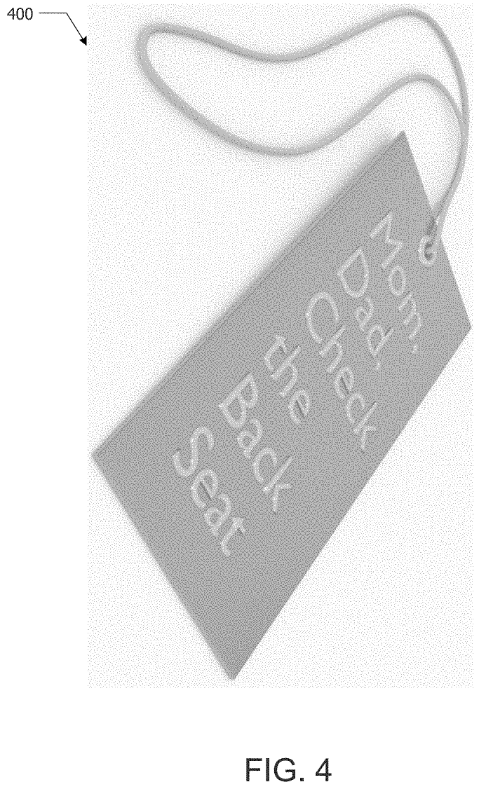

FIG. 4 illustrates yet another example embodiment of an article of manufacture for a warning reminder that human and animal passengers are in the backseat of a vehicle according to the present invention. FIG. 4 shows another example of the reminder device 400 where the device is a hanging tag similar to the reminder device 200 of FIGS. 2a-b while being made with an ordinary rectangular shape. A similar reminder message may appear on the reminder device 400 using noticeable colors to make it visible to the driver. Any shape, color, and message may be included on the reminder device 400 to jog the driver's attention at the crucial moment when the vehicle 101a is parked at a location.

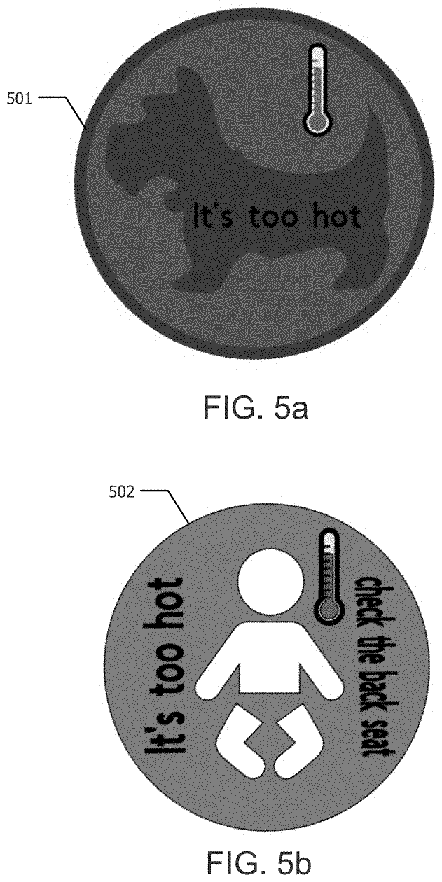

FIGS. 5a-b illustrate additional example embodiments of an article of manufacture for a warning reminder that human and animal passengers are in the backseat of a vehicle according to the present invention. FIG. 5a shows a reminder device 501 that includes a graphical representation of a dog which would immediately remind the driver to recall whether or not the pet is traveling in the vehicle 101a during a current trip. FIG. 5b shows a similar graphical representation of a young child 502 for the same purpose. The reminder devices 501-502 are both shaped as round objects having distinctive colors and messages that may be a sticker or hanging tag according to the principles of the present invention as disclosed herein. Of course, other shapes, such as a warning triangle or stop sign both of which may use a bright red color, can provide its warning message before the driver exits the vehicle 101a.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for a warning reminder that human and animal passengers are in the backseat of a vehicle, the warning reminder comprises:
a message tag body shaped to prompt a driver to check the back seat;
a warning text message to prompt a driver to check the back seat; and
a warning graphic prompt a driver to check the back seat.

2. The warning reminder according to claim 1, wherein the warning reminder further comprises a string hanger coupled to the message body tag to display the warning reminder within a vehicle.

3. The warning reminder according to claim 1, wherein the warning reminder further comprises an attachment mechanism for coupling the message body tag to a vehicle.

4. The warning reminder according to claim 3, wherein the attachment mechanism is a suction cup.

5. The warning reminder according to claim 3, wherein the attachment mechanism is an adhesive in which the message body tag is a sticker.

6. The warning reminder according to claim 3, wherein the sticker couples to a vehicle window having the warning text message and the warning graphic being visible both inside and outside the vehicle.

7. The warning reminder according to claim 1, wherein the warning text message and the warning graphic are made of contrasting colors from the message body tag.

8. The warning reminder according to claim 1, wherein the message body tag is shaped like a child.

9. The warning reminder according to claim 1, wherein the message body tag is shaped like a pet.

10. The warning reminder according to claim 1, wherein the message body tag is shaped like a traffic sign.
